(19) United States
(12) Patent Application Publication
(10) Pub. No.: US 2018/0019603 A1
(43) Pub. Date: Jan. 18, 2018

(54) Surge Protection Circuit and Terminal

(71) Applicant: Guangdong Oppo Mobile Telecommunications Corp., Ltd., Dongguan (CN)

(72) Inventor: Xitong Chen, Dongguan (CN)

(21) Appl. No.: 15/645,040

(22) Filed: Jul. 10, 2017

(30) Foreign Application Priority Data
Jul. 15, 2016 (CN) PCT/CN2016/090227

(51) Int. Cl. H02J 7/00; H02H 9/00; H02H 9/04; H02H 1/00; H04M 19/08

(52) U.S. Cl. CPC H02J 7/0029; H02H 9/04; H02H 1/0007; H02H 9/005; H04M 19/08

(57) ABSTRACT

A surge protection circuit and a terminal are provided. The surge protection circuit is configured to be coupled to a charge management unit. The surge protection circuit includes a voltage stabilizing circuit and a connecting circuit. The voltage stabilizing circuit is configured to be coupled with a system power supply end of the charge management unit. The voltage stabilizing circuit is configured to stable the voltage at the system power supply end of the charge management unit. The connecting circuit has an input end configured to be coupled with the power supply unit-connection end of the charge management unit. The connecting circuit has an output end configured to be coupled with the system power supply end of the charge management unit. The connecting circuit is configured to be turned on when the voltage at the power supply unit-connection end exceeds a voltage threshold.

### CROSS-REFERENCE TO RELATED APPLICATION(S)

This application claims priority to International Application No. PCT/CN2016/090227, filed on Jul. 15, 2016, the content of which is incorporated by reference herein in its entirety.

### TECHNICAL FIELD

The present disclosure relates to the field of circuits, and particularly to a surge protection circuit and a terminal.

### BACKGROUND

With the development of terminal (such as cell phone) industry, requirements on the safety specification thereof are more stringent. At the same time, manufacturers have improved the requirements on the safety specification accordingly, for example, requirements on terminal anti-surge capacity. Currently, protection is generally improved by adding a large number of devices, or the anti-surge ability is improved by adding a larger number of capacitors with larger capacity. However, these measures increase the cost of equipment and occupy the space of a printed circuit board (PCB); this is also undesirable for terminals with high requirements on small volumes. How to improve the terminal anti-surge capacity without adding too much cost or occupying the PCB space is the goal pursued by the manufacturers.

### BRIEF DESCRIPTION OF THE DRAWINGS

In order to illustrate the technical solutions of the implementations of the present disclosure more clearly, drawings to be used in the implementations of the present disclosure will be briefly described below. Obviously, the following drawings are merely illustrations of some implementations of the present disclosure. It will be apparent to those skilled in the art that other drawings may be obtained from these drawings without creative work.

FIG. 1 is a schematic diagram illustrating an exemplary connection circuit of a charge management circuit.

FIG. 2 is a schematic diagram illustrating a surge protection circuit according to an implementation of the present disclosure.

FIG. 3 is a schematic diagram illustrating a surge protection circuit according to another implementation of the present disclosure.

FIG. 4 is a schematic diagram illustrating a surge protection circuit according to another implementation of the present disclosure.

FIG. 5 is a schematic diagram illustrating a surge protection circuit according to another implementation of the present disclosure.

FIG. 6 is a schematic diagram illustrating a surge protection circuit according to another implementation of the present disclosure.

FIG. 7 is a schematic structural diagram illustrating a terminal according to an implementation of the present disclosure.

### DETAILED DESCRIPTION

Technical solutions of implementations of the present disclosure will be described in detail below with reference to the accompanying drawings. Obviously, the described implementations are part of the present disclosure, rather than all implementations. All other implementations obtained by one of ordinary skill in the art without inventive work are intended to be within the scope of the present disclosure.

Terminal

The term “terminal” as used in the implementations of the present disclosure may include, but is not limited to, a device configured to be coupled via a wired line and/or receive/transmit communication signals via a wireless interface. Examples of the wired line may include, but are not limited to, at least one of a public switched telephone network (PSTN), a digital subscriber line (DSL), a digital cable, a cable used for direct connection, and/or another data connection line or network connection line. Examples of the wireless interface may include, but are not limited to, a wireless interface for a cellular network, a wireless local area network (WLAN), a digital television network such as a digital video broadcasting-handheld (DVB-H) network, a satellite network, an AM-FM broadcast transmitter, and/or another communication terminal.

A terminal configured to communicate via a wireless interface may be referred to as a “wireless communication terminal”, a “wireless terminal”, and/or a “mobile terminal”. Examples of a mobile terminal may include, but are not limited to, a satellite or cellular telephone, a personal communication system (PCS) terminal capable of combining cellular radio telephone and data processing, fax, and data communication capabilities, a personal digital assistant (PDA) equipped with radio telephone capacity, pager, Internet/Intranet access capacity, Web browser, notebook, calendar, and/or global positioning system (GPS) receiver, and a laptop and/or a handheld receiver or another electronic device equipped with radio telephone capacity.

The term “terminal” as used in the implementations of the present disclosure may include a power bank; the power bank can accept the charging of an adapter, so as to store energy and provide energy for other electronic devices.

Surge or Electrical Surge

The term “surge” as used in the implementations of the present disclosure refers to an occurrence of an instant surge peak exceeds a stable value. Surge includes a surge voltage and a surge current. An anti-surge circuit (also known as a surge protection circuit) can effectively absorb the sudden huge energy to protect the equipment from being damaged.

Anti-Surge Capacity

The term “anti-surge capacity” as used in the implementations of the present disclosure generally includes the anti-surge capacity of a charge end of a terminal and the anti-surge capacity of a power supply unit-connection end of the terminal. The surge protection circuit of the implementations of the present disclosure can mainly improve the anti-surge capacity of the power supply unit-connection end; for example, the surge protection circuit can improve the anti-surge capacity of a battery connection end of a charge management unit of a cell phone. Currently, most phones have built-in batteries, and the surge protection circuit of the battery connection end is mainly for the protection of cell phone testing in a production process of cell phone manufacturers.

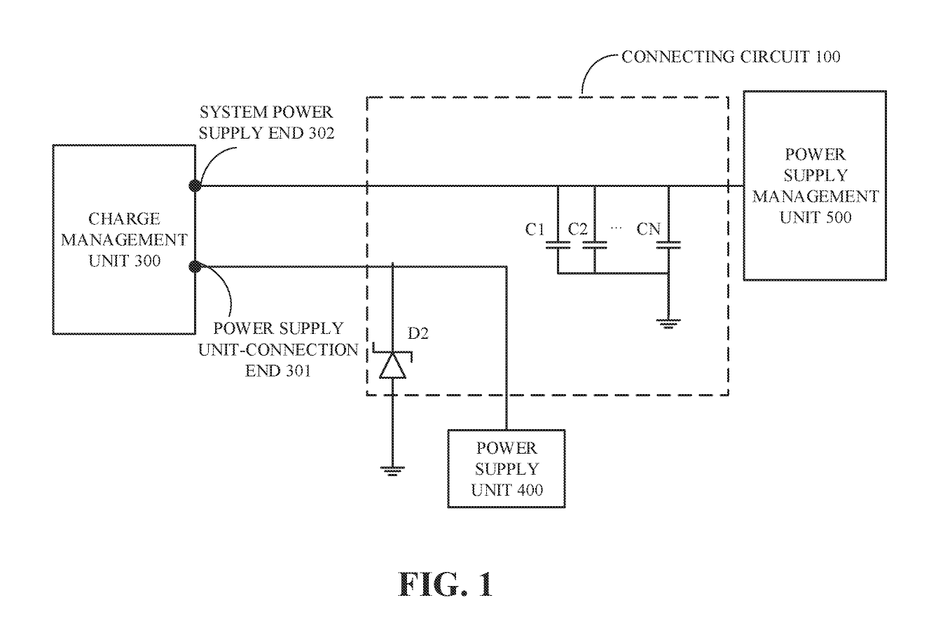

FIG. 1 is a schematic diagram illustrating a connection circuit of a charge management circuit for implementation of the technical solutions of the present disclosure. The circuit structure illustrated in FIG. 1 includes a connecting circuit 100, a charge management unit 300, a power supply unit 400, and a power supply management unit (PMU) 500. A power supply unit-connection end 301 of the charge management unit 300 is coupled with the power supply unit 400. A system power supply end 302 of the charge management unit 300 is coupled with the PMU 500. The connecting circuit 100 includes a voltage stabilizing diode D2 and at least one capacitor. When more than one capacitor is used, the capacitors can be coupled in parallel, for example, a capacitor C1, a capacitor C2 . . . a capacitor C3 can be coupled in parallel. One end of each of the capacitors C1 to Cn coupled in parallel is configured to be coupled to the system power supply end 302 of the charge management unit 300, specifically, coupled between the system power supply end 302 and the PMU 500. The other end of each of the capacitors C1 to Cn coupled in parallel is configured to be grounded. A cathode of the voltage stabilizing diode D2 is configured to be coupled with the power supply unit-connection end 301 of the charge management unit 300, in particular, coupled between the power supply unit-connection end 301 and the power supply unit 400. An anode of the voltage stabilizing diode D2 is configured to be grounded.

Take a cell phone as an example, as illustrated in FIG. 1, the power supply unit 400 is coupled to the charge management unit 300 of the cell phone. The charge management unit 300 can convert the voltage at the power supply unit 400 (such as a battery voltage (VBAT)) into a system power supply voltage (VPH_PWR) and output the converted voltage to the PMU 500 of the cell phone. Since the PMU 500 has a large current consumption, in order to ensure the stability of the system power supply voltage, that is, the VPH_PWR, it is necessary to couple multiple capacitors in parallel to the system power supply, such as the above-mentioned capacitors C1˜Cn. In order to achieve current division on the power supply, some devices on the mother board of the cell phone are coupled to the power supply unit-connection end 301 of the charge management unit 300, while others are coupled to the system power supply end 302 of the charge management unit 300. In an instant of installing the battery of the cell phone, or when a voltage is applied to the power supply unit-connection end 301 to test the function of the cell phone, a large current pulse and a voltage spike are generated at the power supply unit-connection end 301. Since fewer capacitors are coupled to the power supply unit-connection end 301, devices with weak anti-surge capacitor coupled to the power supply unit-connection end 301 are easy to be damaged, and this may cause some of the features of the cell phone to fail.

In order to protect the devices with weak anti-surge capacitor coupled to the power supply unit-connection end 301, a surge protection circuit can be provided. For this purpose, for example, a surge protection circuit can be coupled to the power supply unit-connection end 301. However, coupling of the surge protection circuit directly to the power supply unit-connection end 301 needs to add redundant devices, this will increase the occupied area of the PCB board, and will increase the cost. In view of this, implementations of the present disclosure provide a surge protection circuit, which can realize surge protection function under the premise of increasing the number of devices as little as possible.

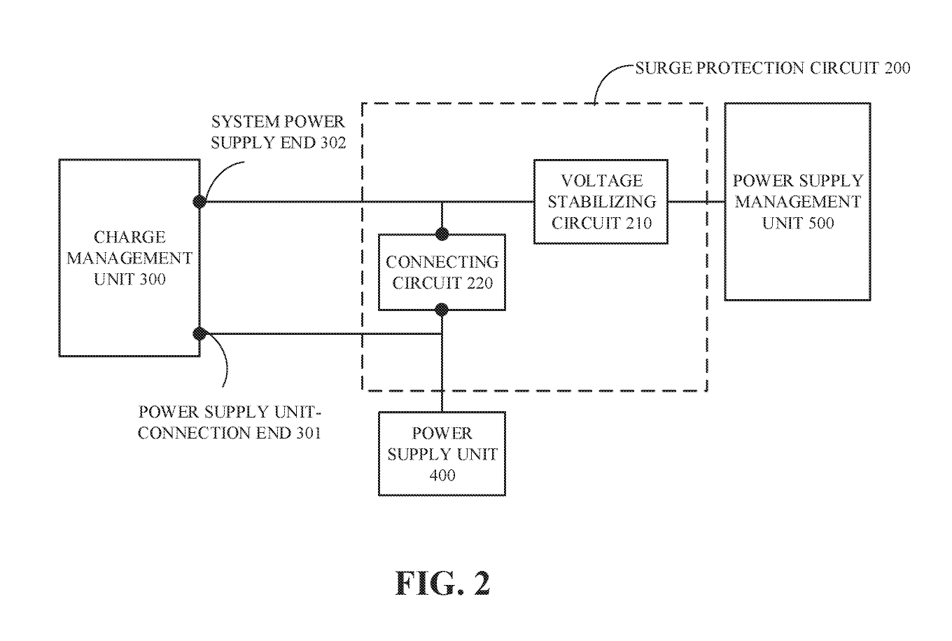

FIG. 2 is a schematic diagram illustrating a surge protection circuit 200 according to an implementation of the present disclosure. The surge protection circuit 200 is applicable to a terminal such as a cell phone, a tablet PC, a PDA, a point of sale (POS), or an on-board computer.

The surge protection circuit 200 illustrated in FIG. 2 is coupled with a charge management unit 300, which will be described below separately.

Charge Management Unit 300

The charge management unit 300 is used to manage the charging and discharging processes of charging units (e.g., batteries) coupled thereto, from this perspective, the charge management unit 300 can also be referred as a charging/discharging management unit. The charge management unit 300 may include at least a discharging circuit and a voltage drop conversion circuit. During charging of the battery, the charge management unit 300 can cause a charging current and a charging voltage to stabilize within a preset range, thereby achieving a safe and controllable charging process. During discharging of the battery, the charge management unit 300 can cause an output current and an output voltage to stabilize at a preset value, thereby enabling stable voltage and current supply.

Surge Protection Circuit 200

The surge protection circuit 200 includes a connecting circuit 220 (can be referred to as a first circuit) and a voltage stabilizing circuit 210 (can be referred to as a second circuit). The voltage stabilizing circuit 210 can also be referred to as a voltage regulation circuit or regulation circuit for short.

One end of the voltage stabilizing circuit 210 is coupled with a system power supply end 302 of the charge management unit 300. Alternatively, the voltage stabilizing circuit 210 may further be used to stabilize the voltage at the system power supply end 302 of the charge management unit 300. One end of the connecting circuit 220 is coupled with a power supply unit-connection end 301 of the charge management unit 300. The other end of the connecting circuit 220 is coupled with the system power supply end 302 of the charge management unit 300 and the voltage stabilizing circuit 210. In other words, the other end of the connecting circuit 220 is coupled between the system power supply end 302 and the voltage stabilizing circuit 210 that are coupled to each other. When the voltage at the system power supply end 302 exceeds a voltage threshold, the connecting circuit 220 can be turned on to connect the power supply unit-connection end 301 and the voltage stabilizing circuit 210, whereby the current can flow towards the voltage stabilizing circuit 210 from the power supply unit-connection end 301 via the connecting circuit 220, and the voltage stabilizing circuit 210 can share the voltage at the power supply unit-connection end 301.

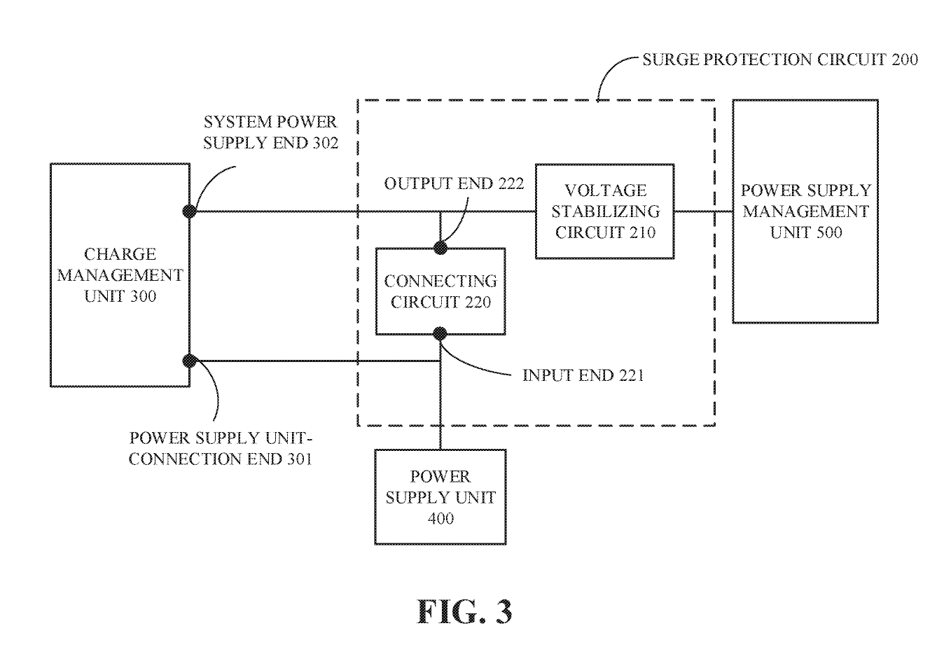

As illustrated in FIG. 3, one end of the connecting circuit 220 that is coupled with the power supply unit-connection end 301 can act as an input end 221, and the other end of the connecting circuit 220 that is coupled with the system power supply end 302 and the voltage stabilizing circuit 210 can act as an output end 222. The input end 221 of the connecting circuit 220 is further configured to be coupled with a power supply unit 400 illustrated in FIG. 3.

As further illustrated in FIG. 2 or FIG. 3, the voltage stabilizing circuit 210 is further configured to be coupled with a power supply management unit 500. The charge management unit 300 can convert the voltage at the power supply unit 400 into a system power supply voltage (VPH_PWR) and output the converted voltage to the power supply management unit 500, whereby the power supply management unit 500 can provide required voltage for other units.

By means of the implementation of the present disclosure, the connecting circuit 220 is provided between the power supply unit-connection end 301 and the system power supply end 302 of the charge management unit 300, and the voltage stabilizing circuit 210 is coupled to the system power supply end 302. In the moment of occurrence of a large voltage at the power supply unit-connection end 301 of the charge management unit 300, the connecting circuit 220 can be turned on immediately, whereby the large voltage can be absorbed by the voltage stabilizing circuit 210 coupled to the system power supply end 302 of the charge management unit 300; therefore, the voltage stabilizing circuit 210 can be fully utilized and anti-surge capacities of devices coupled to the power supply unit-connection end 301 of the charge management unit 300 can be enhanced. In terms of the circuit structure of FIG. 2 or FIG. 3, compared with the connection circuit of FIG. 1, structural change is small, and anti-surge capacity of the power supply unit-connection end is enhanced while retaining the voltage regulation performance (that is, voltage stabilization performance) of the circuit structure of FIG. 1.

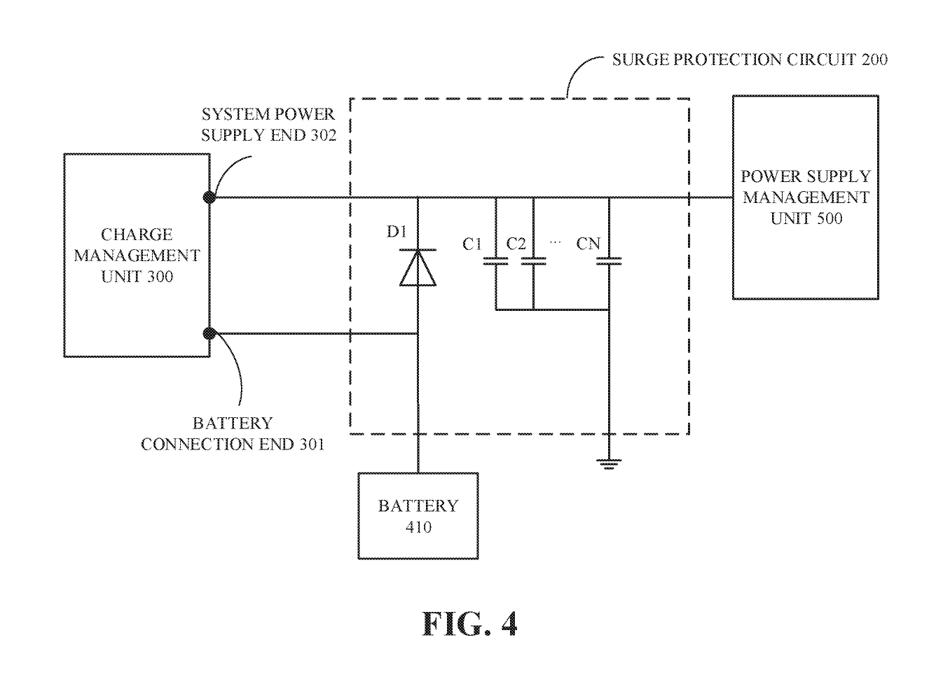

The surge protection circuit 200 according to an implementation of the present disclosure will be described in detail with reference to FIG. 4.

FIG. 4 is a schematic diagram illustrating a surge protection circuit according to an implementation of the present disclosure. In FIG. 4, a connecting circuit 220 is illustrated to include a diode D1, a voltage stabilizing circuit 210 is illustrated to include at least one capacitor (capacitor C1 to capacitor Cn); however, the present disclosure is not limited thereto. The voltage stabilizing circuit 210 can include any form of circuit structure for voltage stabilization. The connecting circuit 220 can include any circuit structure or device with one-way conduction capacity, for example, a MOS transistor (such as an N-type MOS transistor) can be used to replace the diode.

In the circuit structure illustrated in FIG. 4, the anode of the diode D1 is used as an input end 221 of the connecting circuit 220, the cathode of the diode D1 is used as an output end 222 of the connecting circuit 220. One end of each of the at least one capacitor of the voltage stabilizing circuit is configured to be coupled with the system power supply end 302 of the charge management unit 300, and the other end of each of the at least one capacitor is configured to be grounded. In a situation where a MOS transistor is used in the connecting circuit 220, the drain of the MOS transistor is used as the input end 221 of the connecting circuit 220, the source of the MOS transistor is used as the output end 222 of the connecting circuit 220, and the gate of the MOS transistor is grounded.

Compared with the diode, the MOS transistor used in the connecting circuit 220 may increase the occupied area of the PCB, that is because, for the same amount of current flowing through, the size of the MOS transistor is larger than that of the diode; besides, the price of the MOS transistor is higher than the diode, and therefore, the cost of the surge protection circuit may be increased. Moreover, the parasitic capacitance of the MOS transistor itself will affect the conduction time, which can lead to the surge current cannot be timely discharge; therefore, compared to the diode, the reaction time of the MOS transistor may also be affected.

The power supply unit 400 illustrated in FIG. 4 includes a battery 410, and correspondingly, here, the power supply unit-connection end 301 can also be referred as a battery connection end 301.

A surge protection circuit 200 illustrated in FIG. 4 is coupled with a charge management unit 300. The surge protection circuit 200 includes a diode D1 and at least one capacitor, such as capacitor C1, a capacitor C2 . . . and a capacitor Cn. A first end of each of the capacitors C1˜Cn is coupled with the cathode of the diode D1, and a second end of each of the capacitors C1˜Cn is grounded. That is, when more than one capacitor is used, the capacitors can be coupled in parallel with each other. The diode D1 is coupled between a battery connection end 301 and a system power supply end 302 of the charge management unit 300. The anode of the diode D1 is configured to be coupled with a battery connection end 301 of the charge management unit 300. The cathode of the diode D1 is coupled with a system power supply end 302 of the charge management unit 300. When the voltage at the battery connection end 301 of the charge management unit 300 exceeds a voltage threshold, the capacitors C1˜Cn can share this voltage via the diode D1.

As one implementation, the maximum voltage value that can be shared by the voltage stabilizing circuit 210 is associated with the total capacitance value of the at least one capacitor C1˜Cn, that is, the anti-surge capacity provided by the surge protection circuit 200 is associated with the total capacitance value of capacitors coupled in parallel to the system power supply end 302 of the charge management unit 300. The greater the number of capacitors coupled in parallel or the greater the capacitance of a single capacitor, the stronger the anti-surge capacity will be provided by the surge protection circuit 200. For example, if the total capacitance value of the capacitors C1˜Cn coupled in parallel is 100 μF, the maximum voltage value that shared by the voltage stabilizing circuit 210 can reach 60V. Through actual test and verification, we found that, the surge protection circuit according to implementations of the present disclosure can improve the anti-surge capacity by 40V˜80V.

As one implementation, the magnitude of the voltage threshold is related to the conduction voltage of the diode D1, for example, the voltage threshold may range from 0.3V˜0.4V. The diode D1 may be a conventional diode. The lower the conduction voltage of the diode D1, the more sensitive the surge protection circuit 200 is to the external voltage pulse on the input end 221 and the better the protection effect of the surge protection circuit 200 on the devices coupled to the power supply unit-connection end 301 of the charge management unit 300. When the voltage at the anode of the diode D1 reaches the conduction voltage, the diode D1 is turned on, such that the voltage at the power supply unit-connection end 301 of the charge management unit 300 can be transferred to the capacitors C1˜Cn to be shared.

By means of the implementation of the present disclosure, the diode D1 is coupled between the power supply unit-connection end 301 of the charge management unit 300 and the system power supply end 302 of the charge management unit 300. At the moment a large voltage occurs on the power supply unit-connection end 301 of the charge management unit 300, the diode D1 can be turned on immediately, such that the large voltage can be absorbed by capacitors C1˜Cn coupled to the system power supply end 302. In this way, the at least one capacitor coupled to the system power supply end 302 can be fully utilized, devices with weak anti-surge capacities coupled to the power supply unit-connection end 301 can be prevented from being damaged, and this technical solution will not add too much cost or take up too much PCB space.

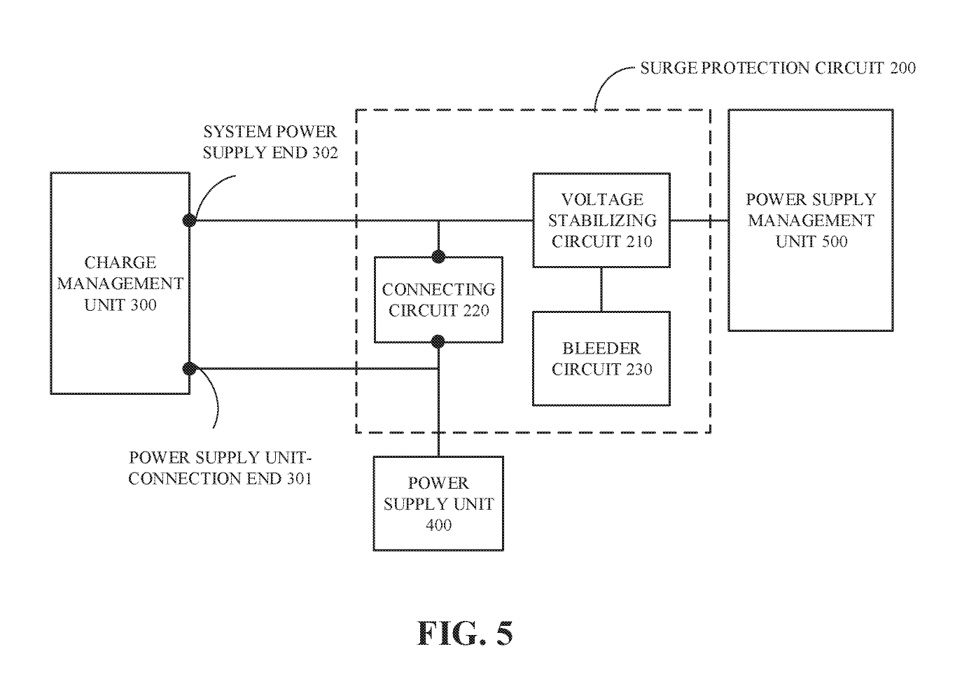

FIG. 5 is a schematic diagram illustrating a surge protection circuit 200 according to another implementation of the present disclosure. As illustrated in FIG. 5, in addition to a voltage stabilizing circuit 210, a connecting circuit 220, the surge protection circuit 200 further includes a bleeder circuit 230, which will be described in detail below.

Bleeder Circuit 230

The bleeder circuit 230 is coupled with the voltage stabilizing circuit 210, and is used to discharge the voltage accumulated on the voltage stabilizing circuit 210. The bleeder circuit 230 can include a diode D2. The cathode of the diode D2 is configured to be coupled with a system power supply end 302 of a charge management unit 300. The anode of the diode D2 is configured to be grounded.

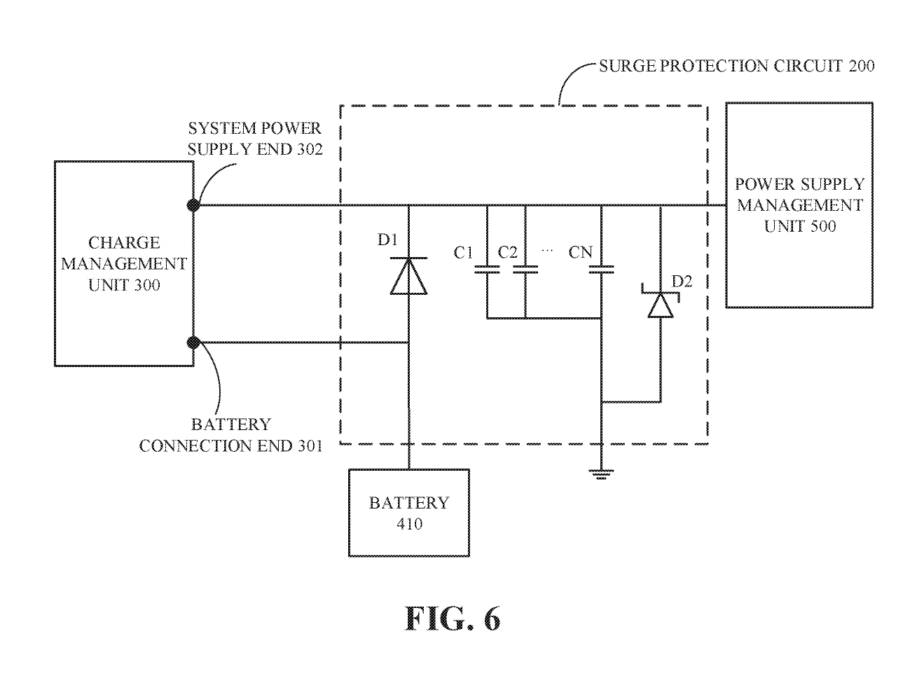

Based on this, FIG. 6 provides an example of the bleeder circuit 230. As illustrated in FIG. 6, the bleeder circuit 230 can include the diode D2. The cathode of the diode D2 is coupled with the cathode of a diode D1, and the anode of the diode D2 is grounded. The diode D2 is used to discharge the voltage at capacitors C1˜Cn. Alternatively, the diode D2 can include a voltage stabilizing diode or a transient voltage suppression (TVS) diode (also referred to as a transient voltage suppressor).

To be more specific, in FIG. 6, in order to provide a voltage discharge circuit for a large voltage accumulated on the voltage stabilizing circuit 210 coupled to a system power supply end 302 of a charge management unit 300, a voltage stabilizing diode can be coupled to the system power supply end 302 of the charge management unit 300. For example, the voltage stabilizing diode D2 coupled to the power supply unit-connection end 301 of the charge management unit 300 of the connecting circuit 100 illustrated in FIG. 1 can be moved to a branch of the system power supply end 302 of the charge management unit 300 and coupled to capacitor C1˜capacitor Cn in parallel. The cathode of the voltage stabilizing diode D2 is coupled to the system power supply end 302 of the charge management unit 300, and the anode of the voltage stabilizing diode D2 is grounded. In this way, a discharge loop is provided for a large voltage at the capacitors C1˜Cn. The voltage stabilizing transistor D2 illustrated in FIG. 6 can be replaced with a TVS diode. In terms of the TVS diode, the cathode thereof is coupled with the cathode of a diode D1 and the anode thereof is grounded, such that a discharge loop can be provided for the voltage accumulated on the capacitors C1˜Cn.

As can be seen, in the surge protection circuit according to the implementation of the present disclosure, the connecting circuit is provided between the power supply unit-connection end of the charge management unit and the system power supply end of the charge management unit, the voltage stabilizing circuit is configured to be coupled to the system power supply end. The voltage stabilizing circuit is also coupled to the connecting circuit. When a larger voltage occurs on the power supply unit-connection end of the charge management unit, the connecting circuit can be turned on immediately, and the large voltage can be absorbed by the voltage stabilizing circuit coupled to the system power supply end of the charge management unit via the connecting circuit. This can prevent devices with weak anti-surge capacities coupled to the power supply unit-connection end from being damaged.

Moreover, the surge protection circuit of the implementation of the present disclosure has advantages of low cost and small space occupation of the PCB, and this makes it possible to improve the anti-surge capacity of the cell phone without increasing the cost and space occupation.

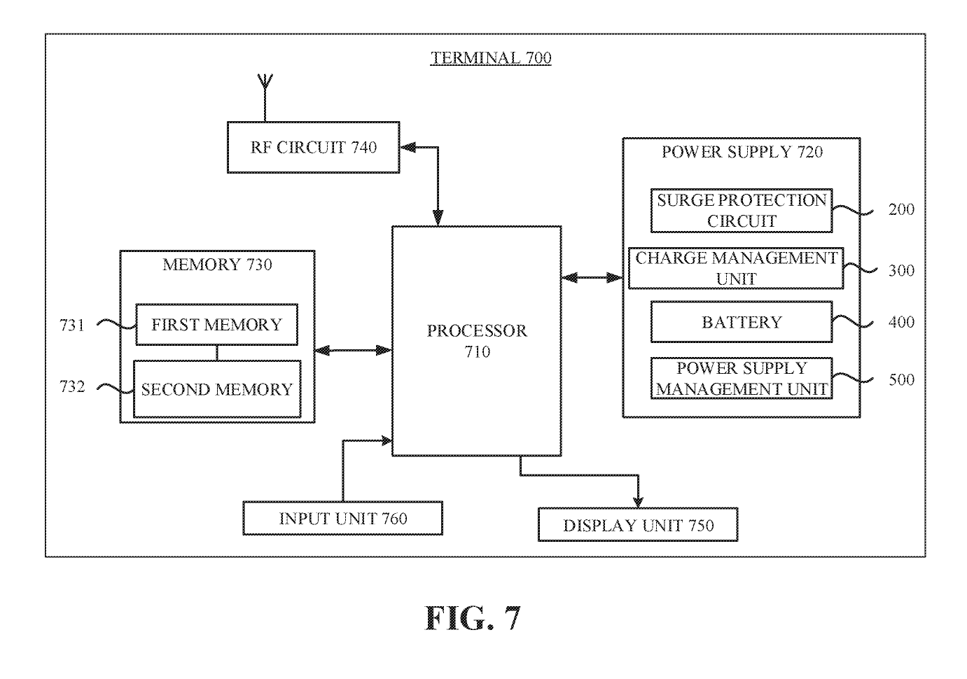

According to another implementation of the present disclosure, there is provided a terminal. FIG. 7 is a schematic structural diagram illustrating the terminal according to the implementation of the present disclosure. A terminal 700 illustrated in FIG. 7 can be a cell phone, a tablet PC, a PDA, a POS, or an on-board computer. The terminal 700 can include a processor 710, a power supply 720, a memory 730, a radio frequency (RF) circuit 740, a display unit 750, and an input unit 760.

The processor 710 is a control center of the terminal 700. The processor 710 can use various interfaces and lines to connect each part of the terminal. The processor 710 can also run or execute software programs and/or modules stored in the first memory 731 as well as call data stored in the second memory 732, so as to achieve overall monitoring of the terminal 700. Alternatively, the processor 710 can include one or more processing units.

The input unit 760 is configured to receive digital or character information input by user and generate a signal input related to the user setting as well as function control of the terminal 700. For example, the input unit 760 can include a touch panel (also known as touch screen) and can be used to collect touch operations of the user performed thereon or nearby, such as operations performed by user with a finger, stylus, or any suitable object or attachment on the touch panel. The touch operation received by the input unit 760 can be used to drive a corresponding connection device according to a preset procedure.

The display unit 750 can be used to display information input by user, information to be provided to the user, and various menu interfaces of the terminal 700.

The RF circuit 740 is configured to receive and/or transmit signals. The processor 710, the memory 730, and the RF circuit 740 can be achieved through one or more chips. For instance, the processor 710, the memory 730, and the RF circuit 740 can be fully integrated in one or more chips; alternatively, the processor 710 and the RF circuit 740 may be integrated in one chip while the memory 730 is integrated in another chip, where the particular form is not defined.

The power supply 720 may be integrated with the processor 710 in a single chip or may be separately integrated in another chip. The power supply 720 includes the forgoing surge protection circuit 200, and can further include a charge management unit 300, a power supply unit 400 (such as a battery), and a power supply management unit 500. A power supply unit-connection end 301 of the charge management unit 300 is coupled to the power supply unit 400; a system power supply end 302 of the charge management unit 300 is coupled to a power supply management unit 500.

Further referring to any of FIG. 2 to FIG. 6, the surge protection circuit 200 includes a connecting circuit 220 and a voltage stabilizing circuit 210. The voltage stabilizing circuit 210 is coupled to the system power supply end 302 of the charge management unit 300. One end of the connecting circuit 220 is coupled to the power supply unit-connection end 301 of the charge management unit 300, and the other end of the connecting circuit 220 is coupled between the system power supply end 302 of the charge management unit 300 and the voltage stabilizing circuit 210. When the voltage at the power supply unit-connecting end 301 exceeds a voltage threshold, the connecting circuit 220 is turned on, whereby the voltage stabilizing circuit 210 shares the voltage at the power supply unit-connection end 301 of the charge management unit 300.

In this way, in an instant of installing the power supply unit 400 (such as a battery) or when a voltage is applied to the power supply unit-connection end 301 of the charge management unit 300 to test the function of the terminal 700, with aid of the surge protection circuit 200 of the implementation of the present disclosure, devices with weak anti-surge capacities coupled to the power supply unit-connection end 301 of the charge management unit 300 can be prevented from being damaged.

The surge protection circuit according to implementations of the present disclosure can be used to improve the anti-surge capacity of a battery connection end of a cell phone. It should be noted that, the surge protection circuit can also be used in other terminal equipment to improve the anti-surge capacity of a power supply unit-connection end of a charge management unit of the equipment. The present disclosure is not limited thereto.

One of ordinary skill in the art will appreciate that the units of the various examples described in connection with the implementations disclosed herein can be implemented in electronic hardware, or in a combination of computer software and electronic hardware. Whether these functions are implemented in the form of hardware or software, depending on specific applications and design constraints of the technical solution. The skilled artisan may use different methods to implement the described functions for each particular application, but such implementations should not be considered beyond the scope of the present disclosure.

It will be apparent to those skilled in the art that, for the convenience and simplicity of description, specific processes of the described systems, devices, and units described above may refer to the corresponding processes in the foregoing implementations of the method and will not be repeated here.

The apparatus and method of the implementations of the present disclosure may be implemented in other ways. The implementation of the apparatus described above is merely illustrative. For example, the division of the units is only a logical function division, and there may be other ways of division during actual implementation. For example, multiple units or components may be combined or integrated into another system, or some feature may be ignored or skipped. “Coupling” or “connection” may be either a direct connection or an indirect coupling or communication connection via some interfaces, devices, or units, either electrically, mechanically, or the like.

The units described as separate components may be physically separate, i.e., may be located at one location, or may be distributed over a number of network elements. The components described as units may not be physical units. All or part of the units may be selected according to actual needs to achieve the purpose of the present disclosure.

In addition, the functional units in various implementations of the present disclosure may be integrated in one processing unit, or each unit may be physically present, or two or more units may be integrated in one unit.

The functions, if implemented in the form of software functional units and sold or used as stand-alone products, may be stored in a computer-readable storage medium. Based on such understanding, technical solutions of the present disclosure, either essentially or in part, contributes to the prior art, may be embodied in the form of a software product. The software product is stored in a storage medium, and includes a number of instructions for enabling a computer device (which may be a personal computer, a server, or a network device, etc.) to perform all or part of the steps described in various implementations of the present disclosure. The foregoing storage medium includes a variety of media such as a USB disk, a mobile hard disk, a read-only memory (ROM), a random access memory (RAM), a magnetic disk, or an optical disk.

The above description is only specific implementations of the present disclosure and the scope of the present disclosure is not limited thereto. It will be readily apparent to those skilled in the art that changes or substitutions within the scope of the technical solutions disclosed are intended to be encompassed within the scope of the present disclosure.

What is claimed is:

1. A surge protection circuit configured to be coupled with a charge management unit, the surge protection circuit comprising:
a voltage stabilizing circuit and a connecting circuit, the voltage stabilizing circuit configured to be coupled with a system power supply end of the charge management unit; and
the connecting circuit has an input end configured to be coupled with a power supply unit-connection end of the charge management unit, and an output end configured to be coupled with a system power supply end of the charge management unit, and
the connecting circuit is configured to be turned on when a voltage at the power supply unit-connection end of the charge management unit exceeds a voltage threshold, wherein the voltage stabilizing circuit shares the voltage at the power supply unit-connection end of the charge management unit.

2. The surge protection circuit of claim 1, wherein the connecting circuit comprises a first diode, an anode of the first diode is used as an input end of the connecting circuit, and a cathode of the first diode is used as an output end of the connecting circuit.

3. The surge protection circuit of claim 1, wherein the connecting circuit comprises a MOS transistor, the drain of the MOS transistor is used as an input end of the connecting circuit, and the source of the MOS transistor is used as an output end of the connecting circuit.

4. The surge protection circuit of claim 1, wherein the voltage stabilizing circuit comprises at least one capacitor, and each of the at least one capacitor has a first end configured to be coupled with the system power supply end of the charge management unit, and a second end configured to be grounded.

5. The surge protection circuit of claim 4, wherein the maximum voltage value shared by the voltage stabilizing circuit is associated with the total capacitance value of the at least one capacitor.

6. The surge protection circuit of claim 1, further comprising a bleeder circuit, wherein the bleeder circuit is coupled with the voltage stabilizing circuit and configured to discharge the voltage accumulated on the voltage stabilizing circuit.

7. The surge protection circuit of claim 6, wherein the bleeder circuit comprises a second diode, the cathode of the second diode is configured to be coupled with the system power supply end of the charge management unit, and the anode of the second diode is configured to be grounded.

8. The surge protection circuit of claim 7, wherein the second diode comprises a voltage stabilizing diode or a transient voltage suppression (TVS) diode.

9. The surge protection circuit of claim 1, wherein the input end of the connecting circuit is further configured to be coupled with a power supply unit.

10. The surge protection circuit of claim 1, wherein the voltage stabilizing circuit is further configured to be coupled with a power supply management unit (PMU).

11. The surge protection circuit of claim 1, wherein the surge protection circuit is configured to be used with a mobile terminal.

12. The surge protection circuit of claim 1, wherein the power supply unit-connection end of the charge management unit is a battery connection end of the charge management unit.

13. A terminal, comprising:
a surge protection circuit and a charge management unit coupled with the surge protection circuit, wherein
the surge protection circuit comprises a voltage stabilizing circuit and a connecting circuit, and the voltage stabilizing circuit is coupled with a system power supply end of the charge management unit; and
the connecting circuit has one end coupled with a power supply unit-connection end of the charge management unit, and another end coupled between the voltage stabilizing circuit and a system power supply end of the charge management unit, and the connecting circuit is configured to be turned on when a voltage at the power supply unit-connection end of the charge management unit exceeds a voltage threshold.

14. The terminal of claim 13, wherein the terminal further comprises a power supply unit coupled with an input end of the connecting circuit.

15. The terminal of claim 13, wherein the terminal further comprises a power supply management unit (PMU) coupled with the voltage stabilizing circuit.

16. A surge protection circuit configured to be coupled with a charge management unit, comprising:
a power supply unit-connection end and a system power supply end, wherein the surge protection circuit comprises a first circuit and a second circuit, the first circuit is configured to be coupled with the system power supply end, and the second circuit has one end coupled with the power supply unit-connection end, and another end coupled between the system power supply end and a voltage stabilizing circuit, wherein the system power supply end are coupled to the voltage stabilizing circuit.

17. The surge protection circuit of claim 16, wherein the first circuit is configured to be turned on when a voltage at the power supply unit-connection end exceeds a voltage threshold, wherein the second circuit shares the voltage at the power supply unit-connection end of the charge management unit.

18. The surge protection circuit of claim 16, wherein the first circuit comprises one of a diode and a MOS transistor.

19. The surge protection circuit of claim 16, wherein the second circuit comprises at least one capacitor.

20. The surge protection circuit of claim 16, wherein an end of the first circuit coupled with the power supply unit-connection end is used as an input end, and another end of the first circuit coupled between the system power supply end and the voltage stabilizing circuit is used as an output end.
